(19) United States
(12) Patent Application Publication
(10) Pub. No.: US 2024/0365708 A1
(43) Pub. Date: Nov. 7, 2024

(54) PICKING UNIT AND MACHINE FOR PICKING FIBER PLANTS

(71) Applicant: HYLER BV, Sint-Baafs-Vijve (BE)

(72) Inventor: Niels BAERT, Sint-Baafs-Vijve (BE)

(21) Appl. No.: 18/580,584

(22) PCT Filed: Jul. 18, 2022
(86) PCT No.: PCT/IB2022/056597

§ 371 Date: Jan. 18, 2024

(30) Foreign Application Priority Data
Jul. 19, 2021 (BE) 2021/5565

(51) Int. Cl. A01D 45/06; A01D 57/20; A01D 69/02; A01D 69/03

(52) U.S. Cl. CPC A01D 45/065; A01D 57/20; A01D 69/02; A01D 69/03

(57) ABSTRACT

Fibre plant picking unit configured to be mounted on a vehicle chassis for picking hemp, comprising one or more picking elements, wherein each picking element comprises: —a frame part; —mounting means for mounting the frame part releasably on the vehicle chassis; and —a fibre plant picking and transport installation arranged on the frame part, comprising: —a plurality of pulleys; —at least one pair of endless conveyor belts trained over the plurality of pulleys and configured to grip the fibre plants therebetween and to pick and then transport them in gripped state, wherein in each case at least one of the pulleys corresponding with a conveyor belt is a drive pulley; and —a plurality of drive motors, wherein each of the drive motors is configured to drive only one or only two drive pulleys of a corresponding conveyor belt.

The present invention relates to a picking unit, picking machine and a method for picking and processing fibre plants, such as hemp plants and/or flax plants.

Numerous different machines have been developed over time for harvesting and subsequent processing of fibre plants. There are picking machines with which the fibre plants can be picked and with which the picked fibre plants can be placed flat on the ground surface in rows (swathes). Numerous variants of this type of processing machine are known. All these variants are however configured only to pick relatively short fibre plants, such as flax.

Other processing machines are known for picking and further processing relatively long fibre plants such as hemp. As a result of the great differences in properties between the different fibre plants, inter alia in respect of properties such as length, but also the composition of the fibre plants, the designs of flax picking machines often differ from those of hemp picking machines. The known hemp picking machines are further often not optimally configured for quickly and efficiently processing the hemp.

It is an object of the invention to provide a picking unit and picking machine in which fibre plants can be picked and further processed in efficient manner.

According to a first aspect of the invention, a fibre plant picking unit configured to be mounted on a vehicle chassis for picking fibre plants is provided, wherein the fibre plant picking unit comprises one or more picking elements and wherein each picking element comprises:
a frame part;
mounting means for mounting the frame part releasably on the vehicle chassis; and
a fibre plant picking and transport installation arranged on the frame part, comprising:
   a plurality of pulleys;
   at least one pair of endless conveyor belts trained over the plurality of pulleys and configured to grip the fibre plants therebetween and to pick and then transport them in gripped state, wherein in each case at least one of the pulleys corresponding with a conveyor belt is a drive pulley and wherein an imaginary throughflow space through which the fibre plants are transported is defined between the at least one pair of conveyor belts; and
   a plurality of drive units, wherein each of the drive units has only one drive motor, which drive motor is configured to drive only one or only two drive pulleys of one or more corresponding conveyor belts and wherein each of the drive units is positioned adjacently of the relevant throughflow space.

Positioning the driver units adjacently of the throughflow space (i.e. at a position shifted laterally relative to the plane of the frame part) prevents on one hand that the fibre plants advanced in the throughflow space by the conveyor belts are blocked or impeded in any way by (a part of) the drive unit and ensures on the other hand that the amount of space taken up by the drive unit in height direction can remain limited. The fibre plant picking unit can hereby take a very compact form.

According to an embodiment of the invention, at least one of the drive units has only one drive motor, and the drive unit is configured to drive only one drive pulley. In this embodiment the coupling between the drive motor and drive pulley can be realized in very simple manner, for instance by mounting the output shaft of the drive motor directly on the drive pulley. In a determined embodiment the drive shaft of a drive motor is mounted directly on a central rotation element of the drive pulley.

According to a further embodiment, at least one of the drive motors is configured to drive a transmission mechanism, wherein the transmission mechanism is coupled to two adjacent drive pulleys. In other words, in this embodiment a single drive motor drives two drive pulleys. This drive takes place in indirect manner, i.e. via a transmission mechanism. This transmission mechanism is also situated adjacently of the throughflow space so as not to get in the way of the fibre plants to be transported.

The transmission ratio of the transmission mechanism can be substantially 1:1, so that in operative state the rotation speed of the drive motor is equal to the rotation speed of the drive pulley driven by the drive motor. In other embodiments there is however a differing (fixed) transmission ratio.

In embodiments of the invention the drive motor extends as a whole adjacently of the lower part of the throughflow space and/or adjacently of the upper part of the throughflow space. In the case of a direct drive the drive motor is for instance situated adjacently of the lower part (particularly the lower half) of the throughflow space. In the case of an indirect drive the drive motor and the transmission mechanism together extend as a whole adjacently of the throughflow space, for instance adjacently of the lower part (particularly the lower half) of the throughflow space. In embodiments of the invention no part whatsoever of a drive unit extends directly below or above the corresponding conveyor belts. In other words, in these embodiments no part whatsoever of a drive unit lies in any way inside the throughflow space, and there is therefore no risk of obstruction of the transported fibre plants. The drive unit is then further not limitative to the maximum length of fibre plants which can be processed by the machine.

In further embodiments of the invention the fibre picking unit comprises power supply lines for the drive motors, wherein the power supply means comprise connecting points for connecting the power supply lines to a power supply installation, for instance a power supply installation on the vehicle.

In further embodiments the power supply installation comprises a hydraulic pump unit provided on the vehicle. The power supply lines can extend along structural elements of the frame part.

In further embodiments the fibre picking machine is configured such that each of the drive motors can be controlled independently of the remaining drive motors. This for instance makes it possible to drive the conveyor belts at mutually varying speeds.

According to a further embodiment, a plurality of the one or more drive motors is connected to the same power supply lines, preferably in series. The drive motors are for instance hydraulic drive motors, preferably orbit motors or radial piston motors. The drive motors can also be electric, for instance when DC motors are applied.

In determined embodiments each of the motors drives only one single drive pulley of the pulleys of the endless conveyor belts. In other embodiments a drive motor drives two drive pulleys. One or more of the one or more drive motors can for instance drive a pair of drive pulleys of different endless conveyor belts which lie close together.

In a further embodiment the fibre plant picking unit comprises an adjusting mechanism for adjusting the axial position of at least one of the drive motors together with the drive pulley mounted directly thereon relative to the frame part.

In a further embodiment at least one of the drive pulleys is arranged rotatably on a support displaceable along the frame part in axial direction. The adjusting mechanism can here comprise an actuator, preferably a hydraulic or electric actuator, arranged between the support and the frame part. In determined embodiments this actuator can be configured to adjust the axial position of the support and the combination of drive pulley and drive motor arranged thereon.

According to another aspect of the invention, a fibre plant picking machine for picking and processing fibre plants, such as hemp and/or flax, is provided, wherein the fibre plant picking machine comprises:
a self-propelling vehicle, comprising a vehicle chassis with at least one conveyor for transporting picked and processed fibre plants in at least two streams from a first outer end to an opposite second outer end, and at least one delivering unit provided at or close to the second outer end for the purpose of receiving the respective streams of picked, processed and transported fibre plants and then placing the received fibre plants on the ground in at least two rows;
a fibre plant picking unit mounted or mountable on the vehicle chassis, as described here.

The fibre plant picking unit can further comprise:
a first pivotable picking element embodied to pick the lower part of the fibre plants;
a second picking element arranged above the first picking element and embodied to pick the upper part of the fibre plants.

The first picking element can have a first transport installation configured to grip the part of the fibre plants being the lower part relative to the ground surface, pull the gripped fibre plants from the ground along with the roots, and transport the lower parts of the fibre plants to the conveyor of the vehicle: The second picking element can have a cutting unit for cutting the fibre plants at a position between the upper and lower part of the hemp plants, wherein the second picking element has a second transport installation configured to grip the part of the hemp plants being the upper part relative to the ground surface and to transport the upper parts of the fibre plants to the conveyor of the vehicle. The cutting unit can be configured to cut the fibre plants during transport.

The first and second picking element can be arranged relative to each other such that during travel of the vehicle the second picking element first grips and cuts loose the upper parts of the fibre plants and only then does the first picking element grip the lower parts of the fibre plants.

According to a determined embodiment, the fibre plant picking machine comprises first lifting means, arranged between the vehicle chassis and the first picking element, for setting the pivot position of the first picking element relative to the vehicle chassis, and/or further lifting means, arranged between the vehicle chassis and the first picking element and/or between the first and second picking element, configured to set the pivot position of the second picking element relative to respectively the vehicle chassis and/or the first picking means.

The invention also relates to the use of a fibre plant picking unit and/or fibre plant picking machine as described herein.

Further advantages, features and details of the invention will be elucidated with reference to the following description of some embodiments thereof. Reference is made in the description to the accompanying figures, in which:

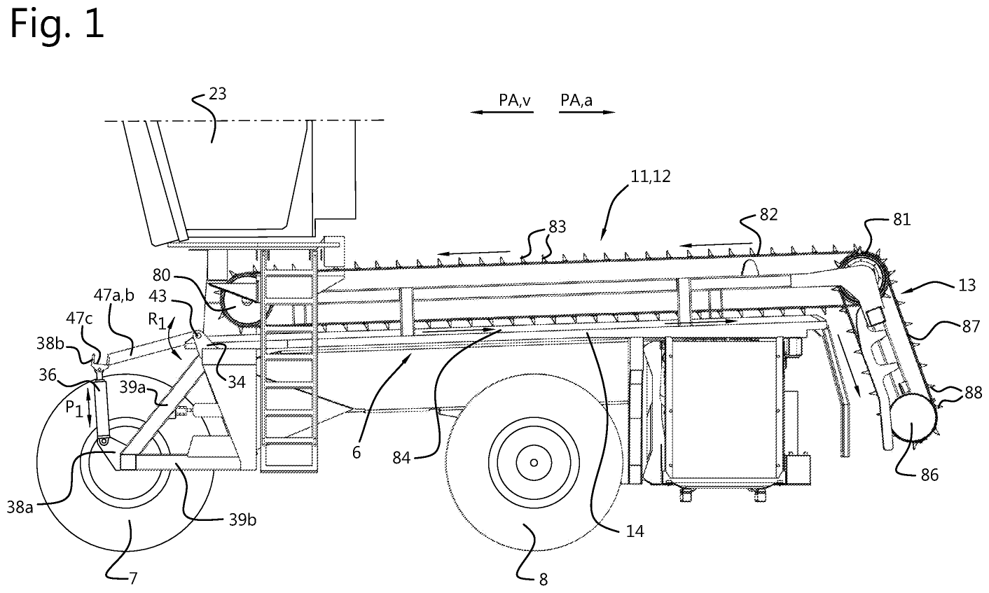

FIG. 1 is a partially cut-away side view of an embodiment of a vehicle according to the invention;

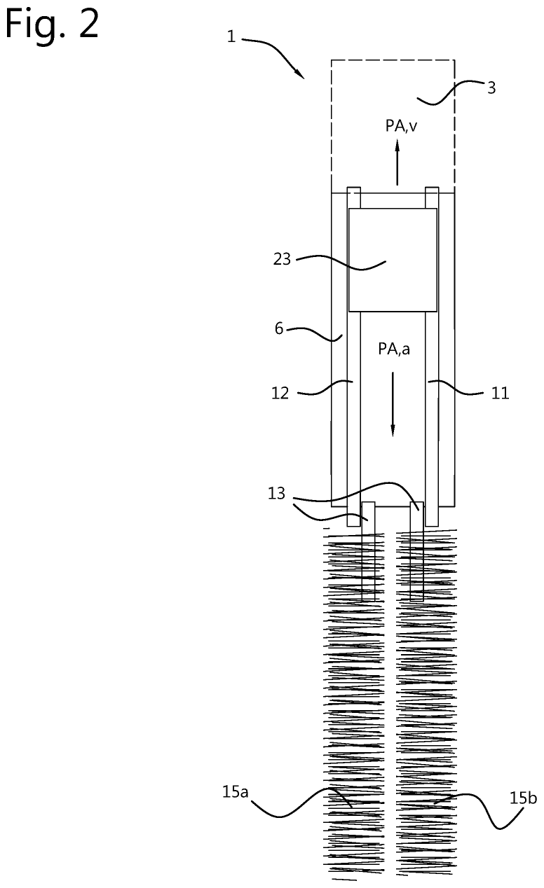

FIG. 2 is a schematic top view of the vehicle of FIG. 1, provided on the front side with a picking unit according to the invention:

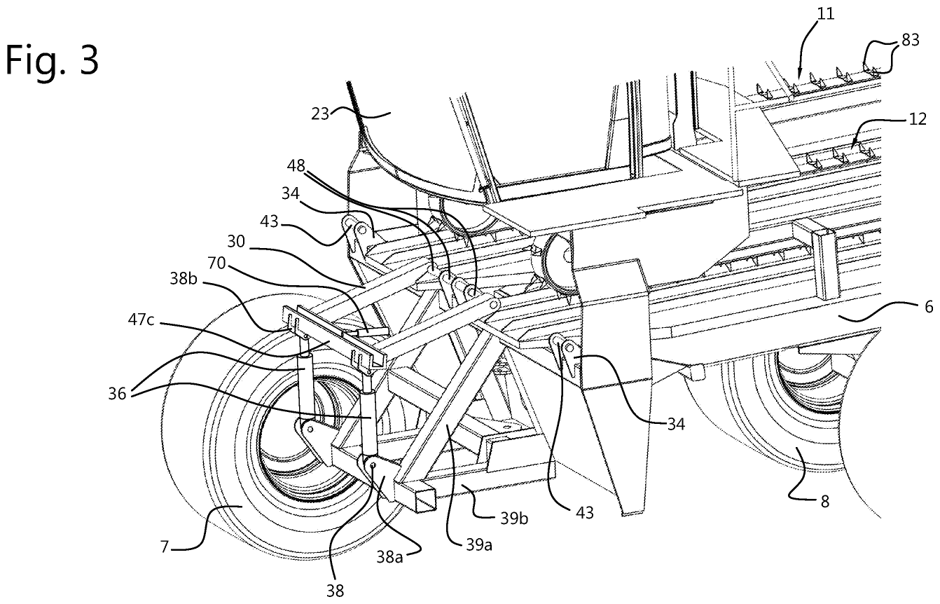

FIG. 3 is a partially cut-away perspective side view of the embodiment of the vehicle according to FIGS. 1 and 2:

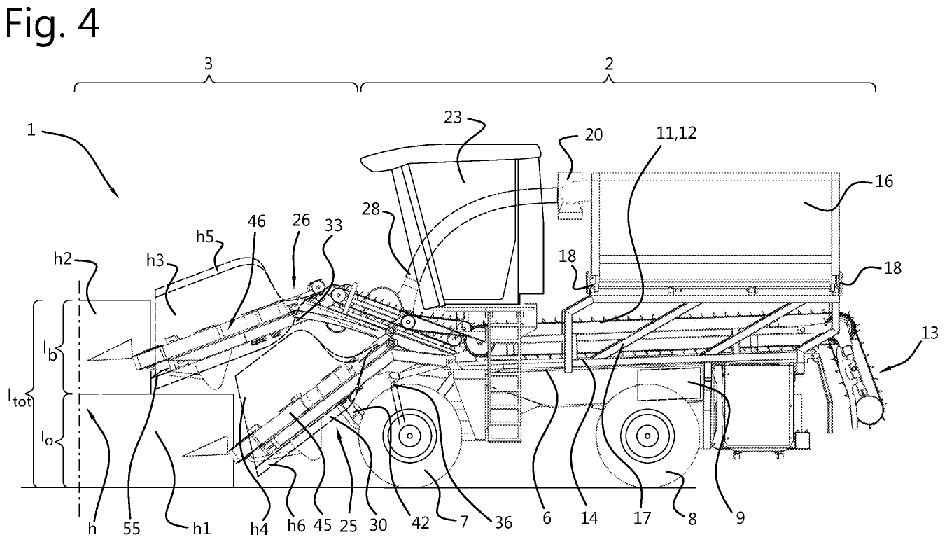

FIG. 4 is a side view of a machine according to an embodiment of the invention, wherein a picking unit 3 according to the invention is mounted on vehicle 1 and is suitable for processing of long fibre plants such as hemp:

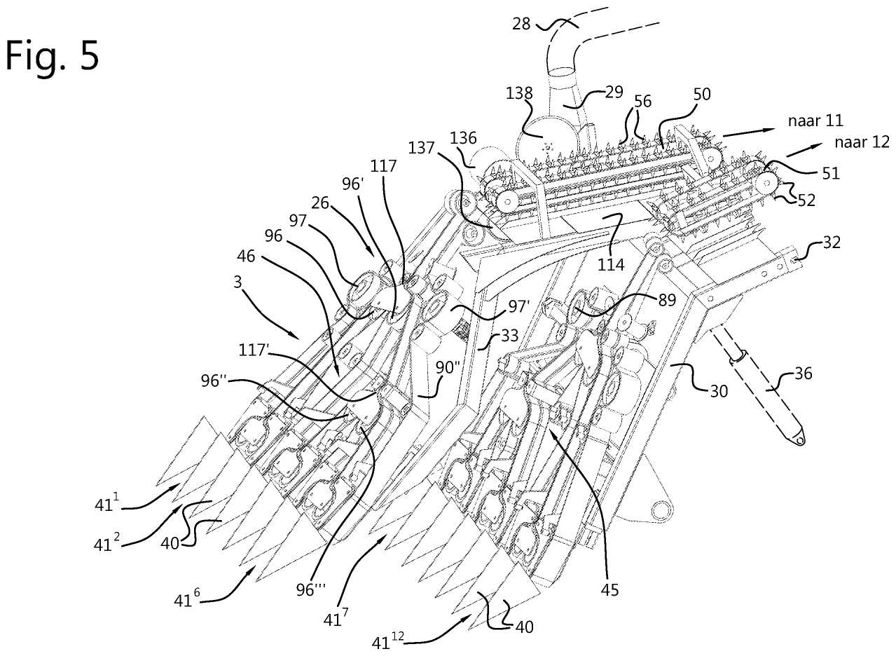

FIG. 5 is a detail view of an embodiment of a picking unit 3 according to the invention:

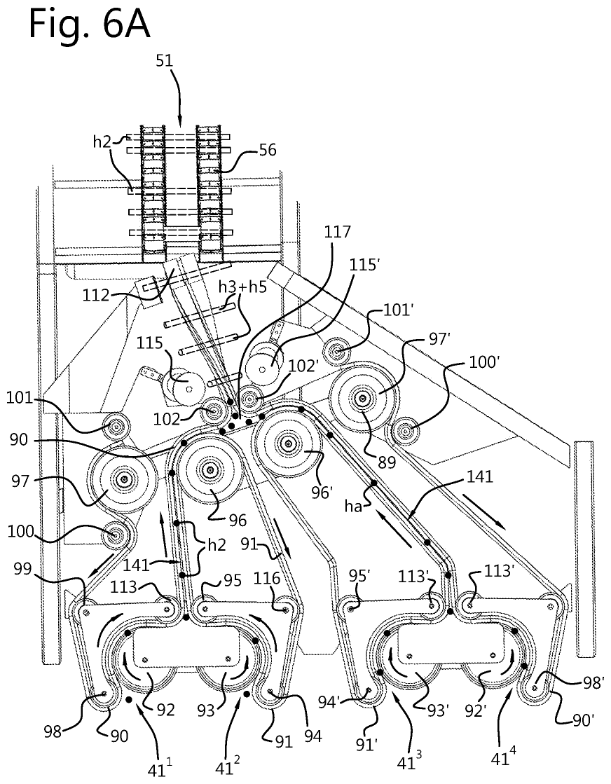

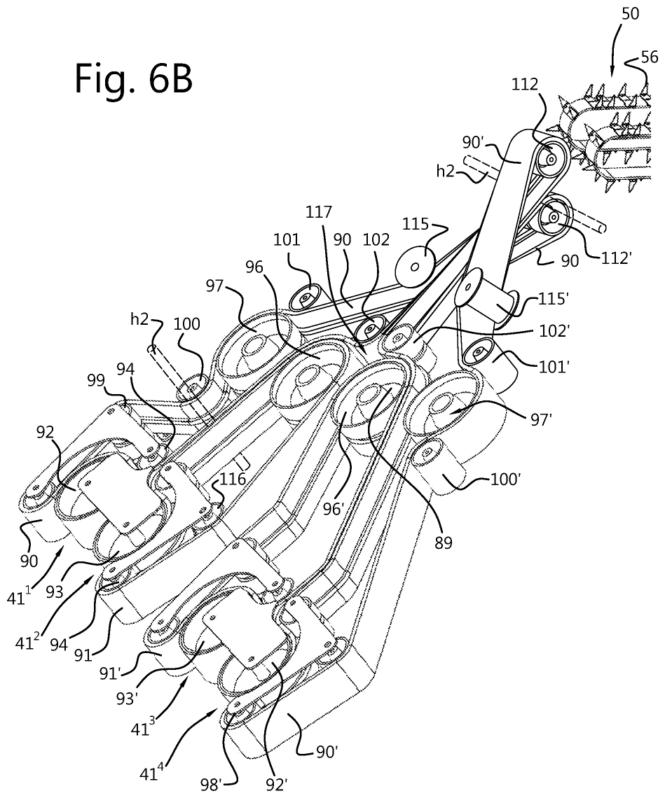

FIGS. 6A and 6B are a top view and a side view of an alternative embodiment of a picking element of a picking unit according to the invention:

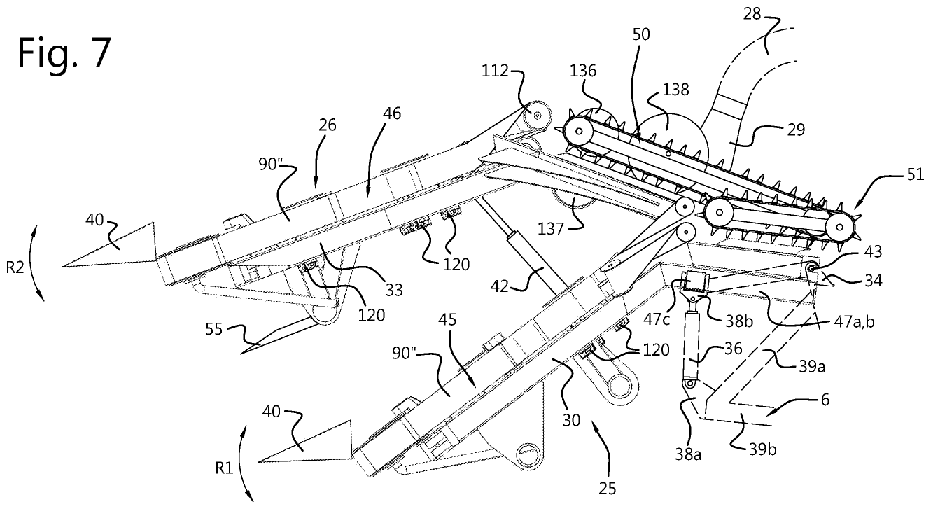

FIG. 7 is a perspective side view of a processing machine provided with a picking unit with two picking elements according to the embodiment of FIG. 5 or of FIGS. 6A and 6B:

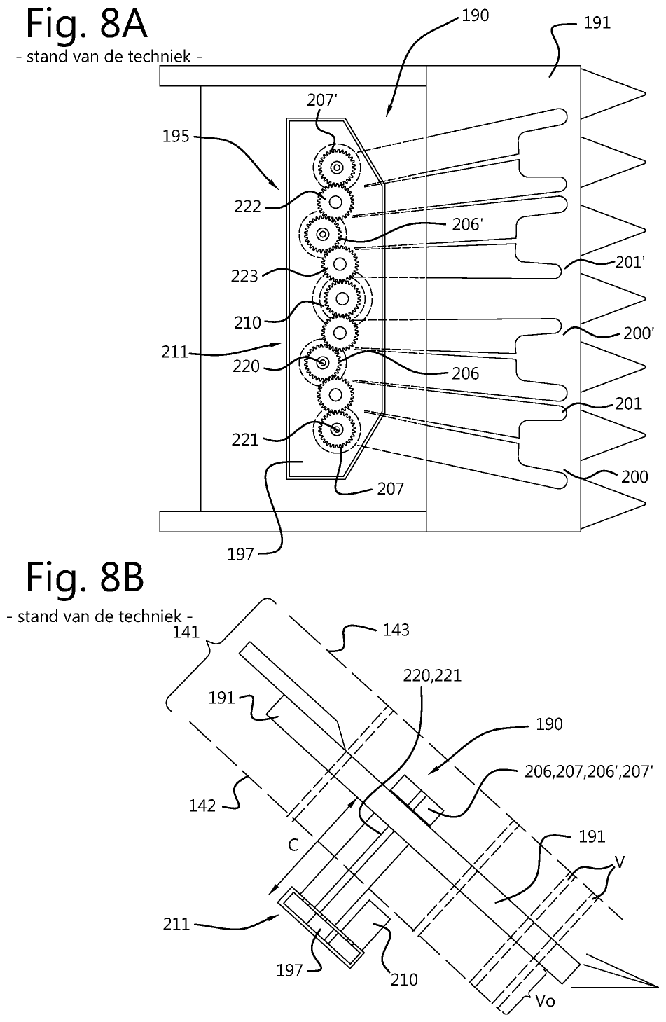

FIGS. 8A and 8B are respectively a top and side view of an example of a picking unit provided with a drive of conveyor belts according to the prior art, wherein all rollers or pulleys to be driven of the conveyor belts are driven with a single drive motor and a central gearbox which extends over the width of the picking unit and in which a transmission mechanism is housed:

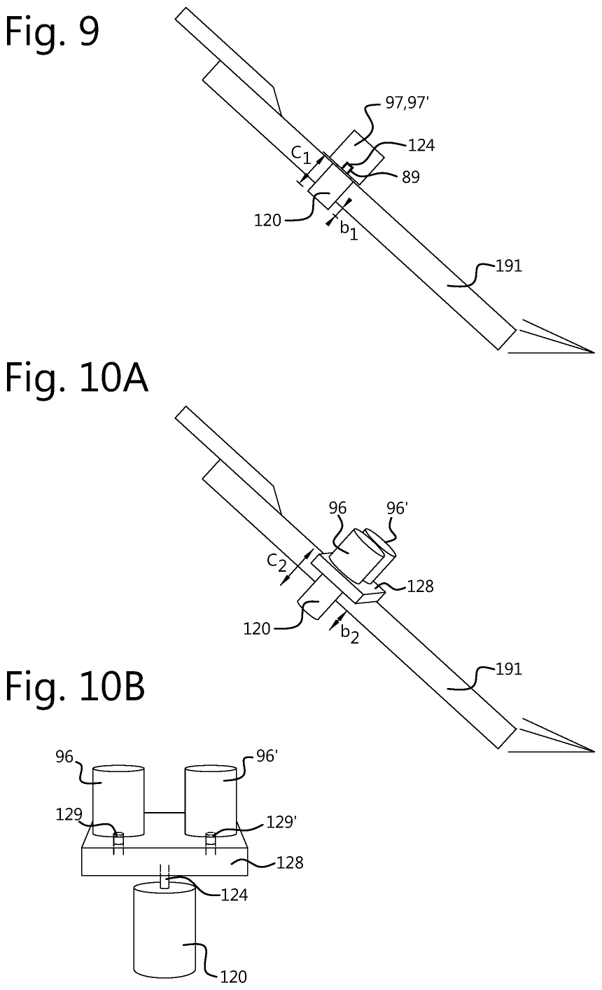

FIG. 9 is a side view of an embodiment according to the invention:

FIGS. 10A and 10B are respectively a perspective side view and a cross-section of a further embodiment of the invention:

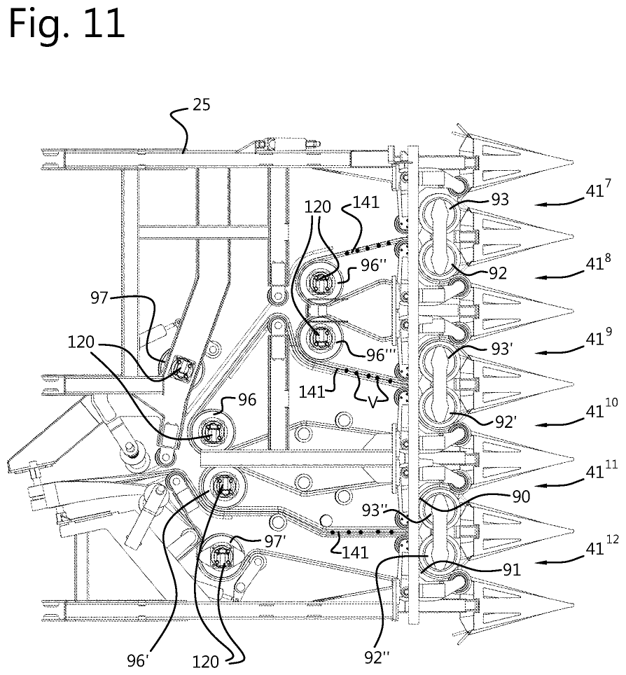

FIG. 11 is a bottom view of a preferred embodiment of a lower picking element 25; and

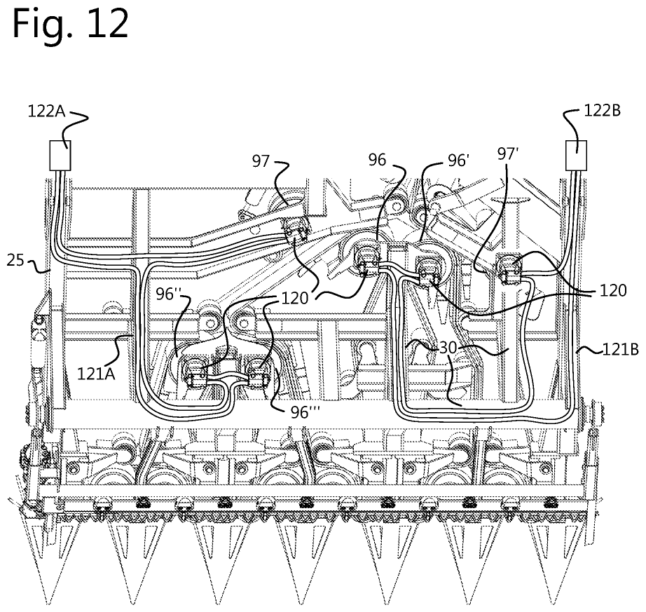

FIG. 12 is a bottom view of the lower picking element 25 according to the preferred embodiment of FIG. 11:

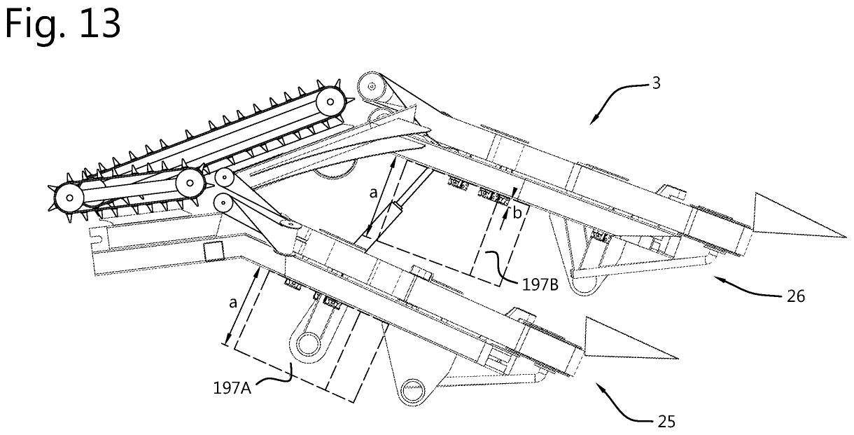

FIG. 13 is a schematic side view of the upper and lower picking element with drive motors according to an embodiment of the invention, with a prior art drive in broken lines:

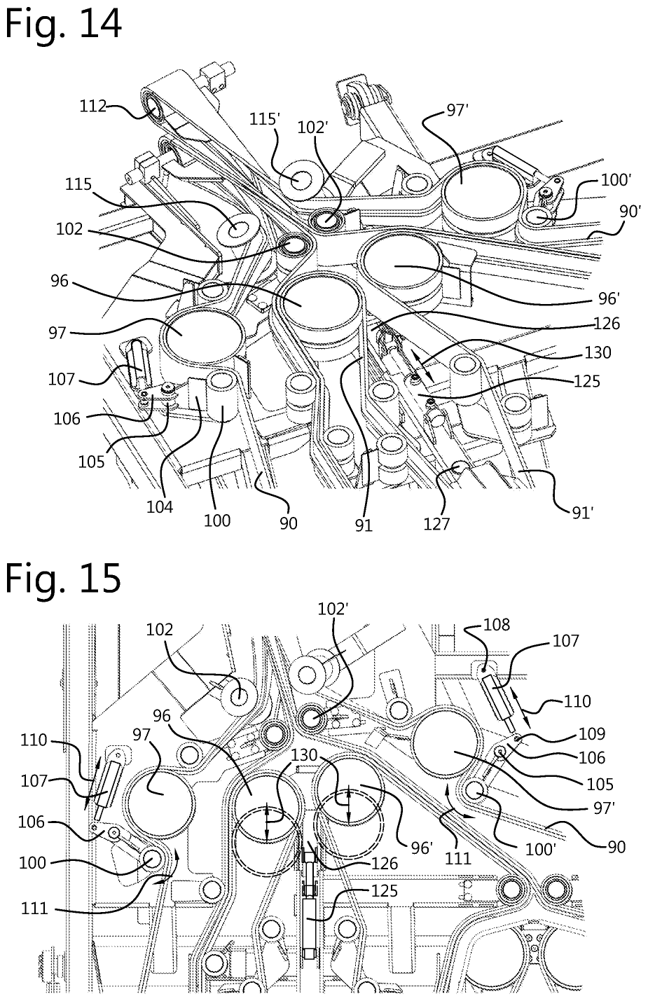

FIG. 14 is a perspective side view of two tensioning mechanisms for tensioning and slackening conveyor belts 90, 90′ as desired relative to respective drive pulleys or rollers 97 and 97′;

FIG. 15 is a top view of the adjusting means for adjusting the axial positions of two drive pulleys 96 and 96′ for tensioning the conveyor belts 91, 91′; and

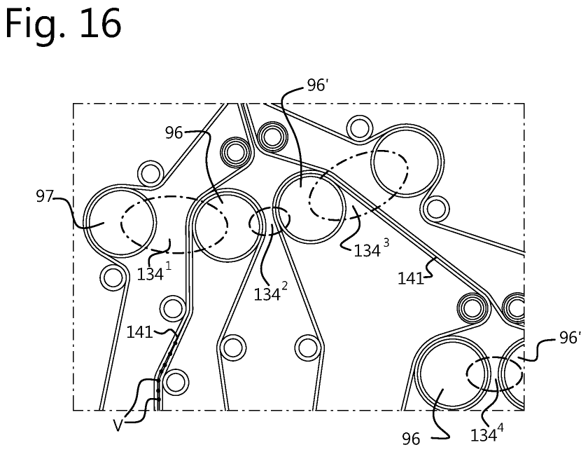

FIG. 16 is a schematic top view of throughflow spaces between different conveyor belt pairs of the picking unit.

Flax is a fibre crop which is cultivated for making linen (clothing, home decor), among other things. The flax plant is usually between 80 and 120 cm long, and is harvested using a drawn or self-propelling flax picking machine. Hemp is likewise a fibre crop which is cultivated for making textile fabrics (clothing or home decor), among other things. The hemp plant is a lot longer than the flax plant. The hemp plant is characteristically between 140 cm and 240 cm in length. Hemp is harvested with a hemp picking machine configured specifically for this purpose.

For this purpose the flax picking machine or hemp picking machine has on the front side a picking unit embodied specifically to pull respectively the flax plants or hemp plants from the ground. The harvested fibre plants are then processed by the flax or hemp picking machine by displacing them to the rear side of the flax or hemp picking machine and placing the fibre plants on the ground surface during travel. Hemp plants must still be cut into two or more parts before they are suitable for placing down on the ground. The flax plants/hemp plants are placed flat on the ground in long rows, also referred to as “swathes”, wherein the stems of the harvested plants extend substantially transversely of the longitudinal direction of the swathes. This placing back of the flax or hemp flat onto the ground surface so that said swathes are created is also referred to as “depositing” or “picking up”. When the flax or hemp plants are placed in rows or swathes, an intermediate space is left between adjacent rows. These spaces are provided in order to prevent the swathes from becoming tangled in each other.

The harvested plants which were placed flat on the ground in swathes are then retted under the influence of a combination of dew, rain and sunlight. The retting of the flax or the hemp by leaving them on the ground (i.e. a field or retting field) for some time is referred to in the field of processing flax as field retting or dew retting. In order to obtain a uniform retting and to prevent rotting of the flax or the hemp, the fibre plants placed flat on the ground in rows must be flipped over regularly. This flipping over of the flax or hemp placed flat on the ground is also referred to as “turning”. The turning of the flax is performed using a drawn or self-propelling flax turning machine, while the turning of the hemp is performed using a drawn or self-propelled hemp turning machine. In determined embodiments of the present invention the flax turning machine and the hemp turning machine are combined into one single machine, which can thus process both hemp and flax. According to determined embodiments of the invention, the flax and hemp turning machines are further also constructed as respective flax and hemp picking machines, and in yet another embodiment the machine is or can be made suitable for at least picking flax, picking hemp, turning flax and turning hemp.

FIG. 1 shows a self-propelling vehicle 2 of a processing machine 1 according to a determined embodiment of the invention. Self-propelling vehicle 2 comprises a vehicle chassis 6 on which four wheels, i.e. two front wheels 7 and two rear wheels 8, are arranged in known manner. In FIG. 1 a part of the front left side of the vehicle has been cut away (i.e. the front left wheel and the relevant part of the wheel suspension) in order to obtain a better view of the construction of the vehicle on the front side. The vehicle is self-propelling, which means that it is provided with its own drive motor whereby a number of the wheels, for instance the two rear wheels, or all the wheels can be driven. The self-propelling vehicle 2 is preferably driven by a number of hydraulic motors, one for each wheel 7, 8, which hydraulic motors are connected to a hydraulic pump unit which is configured to provide a hydraulic medium under pressure via a hydraulic circuit provided in the vehicle. The hydraulic pump unit is driven by a combustion engine, for instance a diesel engine. The combustion engine and hydraulic pump unit together are designated in FIG. 4 in schematic manner with reference numeral 9.

The vehicle is steered from a driver's cab 23 on the front side of the vehicle. Chassis 6 comprises two parallel conveyors 11, 12 formed by a loading floor or platform 14 and two endless conveyor belts provided thereabove. At least one of the endless conveyor belts can here be adjusted in lateral direction so that the intermediate distance between the two conveyor belts can be adjusted, this in order to realize a suitable intermediate distance for shorter or longer swathes. Referring to the top view of FIG. 2, the two conveyors 11, 12 are arranged along both longitudinal edges of vehicle 2 so that a quantity of fibre plants can be transported in axial rearward direction (P_{A,a}) with each of these. In the shown embodiment each of the conveyors 11, 12 comprises an endless conveyor belt 82 which runs on a front roller 80 and a rear roller 81. At least one of the rollers 80, 81 is driven via a drive (not shown). In a determined embodiment the drive comprises a hydraulic motor arranged in the rear (triple) pulley or roller 81. Each of the respective part-rollers of the multiple (triple) pulley is driven separately yet synchronously to each other, preferably according to a determined ratio as desired. So-called carriers 83 are provided on the outer side of conveyor belt 82. These can displace the fibre plants lying on platform 14, at least on guide rails 84 of the platform (FIG. 1), in said axial rearward direction (P_{A,a}) to the rear side of chassis 6. The fibre plants are thus enclosed here between conveyor belt 82 and guide rails 84.

On the rear side of vehicle 2 a delivering unit 13 is arranged for each conveyor 11, 12. In the shown embodiment the delivering unit 13 comprises an endless belt conveyor 87. The endless belt of each of the endless belt conveyors 87 is trained around a roller 86 and around said roller 81 (a belt conveyor 87 therefore sharing this with a conveyor 11 or 12). Driving of delivering unit 13 takes place the first roller 81. This extends obliquely rearward to some extent and is configured to displace the fibre plants coming from respective conveyor 11, 12 downward in dosed and controlled manner so that the fibre plants can be placed on the ground on the rear side of the vehicle. As shown in FIG. 2, when the vehicle moves in an axial forward direction (P_{A,v}), the fibre plants (v) picked or picked up on the front side of the vehicle will be displaced to the rear side of vehicle 2 and will each be placed down on the ground (o) in a separate row 15a. 15b via delivering units 13. In determined applications the rows 15a. 15b of fibre plants are composed of the same parts of the fibre plant, for instance in the case of the relatively short flax plants. In other embodiments the one row is however composed of the lower portions of the harvested fibre plants, while the other row consists of the upper portions of the harvested fibre plants. This is for instance the case when hemp plants are harvested. In both cases the fibre plants are placed flat on the ground, parallel to each other as far as possible, after which said retting can commence.

Vehicle 2 is provided with a picking unit 3 on its front side in order to be able to pick the fibre plants. This can be a first picking unit developed especially for picking long fibre plants (such as hemp) (also referred to herein as a hemp picking unit), or a second picking unit developed especially for picking short fibre plants (such as flax) (also referred to herein as a flax picking unit). Depending on the length of the crop to be picked, a different picking unit must thus be mounted on the vehicle.

Referring to FIGS. 1 and 3 in particular, the chassis comprises on the front side of chassis 6 of vehicle 2 a number of support chassis parts 39a, 39b. The support chassis parts 39b extend in line with the rest of chassis 6 of vehicle 2, while the support parts 39a mounted on support parts 30b and the rest of chassis 6 are disposed obliquely. Chassis 6 is further provided with a number of hinges 48 on which two parallel longitudinal lifting arms 47a, 47b are arranged. Both longitudinal lifting arms 47a, 47b are connected at their outer ends to a transverse lifting arm 47c. The support chassis parts 39a, 39b, longitudinal lifting arms 47a, 47b and transverse lifting arm 47c together form a strong and stable support structure for mounting a number of actuators whereby a picking unit 3 coupled to the chassis 6 of vehicle 2 can be pivoted upward and downward. Together with these actuators the support structure forms the above stated lifting unit.

The pivoting of picking unit 3 is brought about by a number of actuators, for instance electric actuators (motors) or, preferably, lifting cylinders 36, of the lifting unit (FIG. 3). In FIGS. 1 and 3 the actuators are formed by two lifting cylinders 36. In the shown embodiment two lifting cylinders positioned laterally adjacently of each other are provided. In other embodiments use is however only made of a single lifting cylinder, or three or more lifting cylinders are applied. The lifting cylinders are mounted pivotally on the support chassis parts 39a, 39b via hinges 38 and on transverse lifting arm 47c via a mounting support 38b. A further description of the construction of the lifting unit and of the operation thereof will follow below.

Further referring to FIG. 3, chassis 6 is provided on either side of the support chassis parts 39a, 39b with first mounting means 34 for mounting a picking unit 3 thereon in pivotable and releasable manner. The first mounting means 34 can be embodied in numerous ways, but in the shown specific embodiment comprise a number of flanges in which respective pivot shafts 43 can be rotatably mounted.

Each of the different picking units 3 comprises one or more frame parts which can be mounted in pivotable and releasable manner on said first mounting means 34. In the embodiments shown in FIGS. 4, 5 and 6 the picking unit 3 comprises a first, lower hemp picking element 25 and a second, upper hemp picking element 26 placed thereabove. The lower hemp picking element comprises a frame part 30 which can be mounted pivotally and in easily releasable manner on first mounting means 34 of the vehicle using second mounting means 32. The upper hemp picking element 26 comprises a frame part 33 which also takes a pivotable (yet not necessarily easily releasable) form, albeit that in the shown embodiment frame part 33 of the upper hemp picking element 26 is mounted on the frame part 30 of the lower hemp picking element 25 instead of directly on chassis 6 of the vehicle. In other embodiments (not shown) it is however precisely the upper hemp picking element that is mounted on chassis 6 of vehicle 2, and the lower hemp picking element on the upper hemp picking element. In still further embodiments (not shown) the two hemp picking elements are mounted pivotally and releasably on vehicle 2. In yet other embodiments only one picking element is provided, wherein this one picking element is configured to pick shorter hemp plants, such as flax. The flax picking element can in principle have a similar construction as one of the two hemp picking elements 25, 26, and in determined embodiments the flax picking element is even almost identical or wholly identical to a hemp picking element.

For mounting on the chassis 6 of vehicle 2, more particularly on the first mounting means 34 thereof, such as the flanges 34 positioned on or close to the sides of vehicle 2 and having the pivot shafts 43 mounted therein, the picking unit 3, in the shown embodiment the lower hemp picking element 25, is provided with second mounting means 32. The second mounting means 32 are embodied for easy mounting on first mounting means 34. The first and second mounting means 34, 32 together form a mounting hinge between picking unit 3 and vehicle 2, such that picking unit 3 can be pivoted in upward and downward direction around the lying pivot shafts 43.

To make picking unit 3 pivot relative to vehicle 2 the above described lifting unit is utilized. As described above, the lifting cylinders 36 are arranged rotatably on the flanges 38a of chassis 6 at one outer end. On their opposite sides the lifting cylinders 36 are coupled via mounting supports 38b to the transverse lifting arm 47c. Transverse lifting arm 47c of the lifting unit has a substantially U-shaped cross-section, which is clearly visible particularly in FIGS. 1 and 3. The U-shape forms a receiving space for a part of the frame part 30 of the lower hemp picking element 25. In other words, the picking unit 3 can be connected to the lifting unit in simple manner by placing frame part 30 of lower hemp picking element 25 into the transverse lifting arm 47c of the lifting unit from above or, conversely, by simply pressing transverse lifting arm 47c against frame part 30 from below. Finally, the whole is locked by a locking mechanism 70 (FIG. 3), for instance in the form of a remotely controllable extending cylinder which in extended state ensures that picking unit 3 remains locked to the lifting unit. The lifting unit is then ready to lift picking unit 3.

As shown in FIG. 7 with arrows (P₁. P₂), the length of each of the lifting cylinders 36 and 42 is controllable. It will be apparent that when the length of lifting cylinders 36 and/or 42 is increased, frame part 30 and frame part 33 will respectively pivot upward, while the relevant frame part 30, 33 will pivot downward if the length of lifting cylinders is reduced. In this way the height of the free outer end of the picking unit can be varied, for instance in order to adjust the position in which the picking unit grips the fibre plants and pulls them from the ground during travel of the vehicle.

FIGS. 4, 5, 6A, 6B and 7 show an embodiment of a processing machine 1 according to the invention wherein the processing machine is provided with an exchangeable picking unit comprising a first picking element and a second picking element placed thereabove. This embodiment is embodied for picking relatively long fibre plants, such as hemp plants, as shown schematically in the figure. In the shown embodiment the processing machine 1 comprises the above stated self-propelling vehicle 2 and a specific picking unit 3. i.e. a hemp picking unit. The hemp picking unit comprises a lower hemp picking element 25 and arranged thereabove an upper hemp picking element 26. The lower picking element 25 is mounted on the first mounting means of the vehicle in the above stated manner, this such that the first hemp picking element 25 can be pivoted in upward and downward directions (pivoting directions R₁, FIG. 7) by controlling one or more of said lifting cylinders 36. The upper hemp picking element 26 is pivotally arranged via pivot shafts 43 on the lower hemp picking element 25 so that the upper hemp picking element 26 can be pivoted (pivoting directions R₂) relative to the first hemp picking element 25 (and relative to vehicle 2 and the ground surface). The pivoting movement of the upper hemp picking element 26 relative to the lower hemp picking element 25 is driven by a number of further lifting cylinders 42 arranged on frame parts 30, 33, wherein increasing the length of lifting cylinders 42 results in an upward rotation of the upper hemp picking element 26 relative to the lower hemp picking element 25, while reducing the length results in a downward rotation of the upper hemp picking element 26 relative to the lower hemp picking element 25.

FIG. 4 shows schematically that the relatively long fibre plants (h), such as hemp, kenaf, jute or similar fibre plants, have an overall length lₜₒₜ (characteristically between 1.4 and 4.0 metres, 2.4 metres on average). The lower part (h₁) of each of the fibre plants (h) has a length lₒ (for instance 110 cm to 120 cm), while the upper part (h₂) has a length 16 (for instance 120 to 130 cm). In the shown embodiment both lengths lₒ and l_{b} are roughly the same, although in practice these lengths may of course differ. What is important is only that the fibre plants (h) are cut into at least two parts (h₁, h₂) and then processed further by processing machine 1. Said lower hemp picking element 25 is for this purpose made suitable for picking and processing the lower fibre plant parts (h₁), while the upper hemp picking element 26 is intended for picking the upper fibre plant parts (h₂).

The upper hemp picking element 26 comprises a transport installation 46 for gripping hemp plants and transporting them to vehicle 2, while the lower hemp picking element 25 comprises a (preferably wholly or almost wholly identical) transport installation 45 whereby hemp plants can likewise be gripped and transported to vehicle 2. When vehicle 2 travels in a forward direction (P_{A,v}), the upper hemp picking element 26 will reach the hemp plants first. After a short time interval the lower hemp picking element 25 will also reach these same hemp plants. In other words, the engaging position at which the upper hemp picking element 26 engages a determined hemp plant at a determined point in time is shifted relative to the engaging position at which the lower hemp picking element 25 engages a (different) fibre plant at the same point in time. This has the result that the upper hemp picking element 26 first engages the upper part (h₂) of the hemp plants and cuts them loose from the lower part (h₁) with a cutting element 55 (also referred to here as mowing element 55) provided on the front side of the upper hemp picking element 26, while it is after this, so only when upper part h₂ has been cut loose and is already being carried away, that the lower hemp picking element 25 will engage on the lower part (h₁) of the same hemp plant.

The lower hemp picking element 25 is configured to engage the lower part (h₁) of the hemp plant. As a result of the forward movement of vehicle 2 and/or as a result of displacement by means of the transport installation 45 to be described further below the hemp plants are pulled from the ground along with the roots.

As shown in FIG. 4, the gripped upper part (h₂) of a hemp plant (h) which has been cut loose with mowing element 55 is picked up by the upper hemp picking element 26. This upper part (h₂) of the fibre plant comprises a top, flower or plume portion (h₅) and a remaining upper portion (h₃). The top portion (h₅) of the upper part (h₂) of the hemp plant (h) can be removed using a cutting unit 138. The top portion (h₅) is here discharged via discharge means comprising a discharge pipe 28 with an inlet opening close to the cutting unit, a centrifugal fan 20 connected to the discharge pipe and an outlet opening to a receptacle 16 arranged via a frame 17 on the rear side of vehicle 2.

As further elucidated elsewhere, in determined embodiments the two delivering units 13 are configured to place a first row 15a of only lower remaining parts (h₄) of the hemp plant and a second row 15b of only upper remaining parts (h₃) of the hemp plants (h) onto the ground and then have them undergo the desired retting process (FIG. 2).

FIGS. 4 and 5 show a side view of a first embodiment of the hemp picking unit 3, while FIGS. 6A and 6B show views of the lower picking element of a second embodiment of the hemp picking unit and FIG. 7 shows a side view of this embodiment. FIGS. 4, 5 and 7 show the transport installations 45, 46 whereby the hemp plants are gripped and transported to vehicle 2. Each of the transport installations 45, 46 comprises a number of endless belt conveyors, more particularly a first number of endless belt conveyors for gripping the crop, transporting it and tilting the crop during transport, and a second number of endless belt conveyors for receiving the crop from the first number of belt conveyors and transporting the crop to the conveyors on vehicle 2. The second number of conveyors (characteristically 3, 4 or more) is here usually smaller than the first number of conveyors (characteristically 1 or 2).

Guide elements 40 are provided on the front side of both the lower hemp picking element 25 and the upper hemp picking element 26. Their object is to make it possible to be able, when the vehicle and the picking unit 3 mounted thereon are advanced, to push the hemp plants (h) to the side and guide them into a number of, in FIG. 5 six per hemp picking unit (although this can also be a greater or smaller number in other embodiments), passages 41¹-41⁶ for the upper hemp picking element 26 and passages 41⁷-41¹² for the lower hemp picking element 25, all configured to receive and grip the hemp plants. These twelve passages are formed by a number of driven conveyor belts and a number of pulleys. For further details of the embodiment shown in FIG. 5 and the operation thereof reference is made to the embodiment to be described below and shown in FIGS. 6A and 6B.

FIGS. 6A and 6B show an alternative embodiment with only four passages for throughfeed of the plants. The figures show a first passage 41¹ which is formed by the intermediate space between a first driven conveyor belt 90 and roller 92. A second passage 41² is formed by a second driven conveyor belt 91 and roller 93. Likewise, the third passage 41³ and fourth passage 41⁴ are formed by respectively conveyor belt 91′ and roller 93″, and conveyor belt 90′ and roller 92″.

When hemp plants (h, shown in FIG. 6A with black dots in as far as the hemp plants are in upright position and shown with broken lines as soon as the hemp plants have been rotated to the lying position) have found their way into the first passage 41¹ formed between the first driven conveyor belt 90 and roller 92, they are pulled along in the direction indicated by the arrow. Along the first section the hemp plants which have found their way into passage 41¹ are enclosed between the first conveyor belt and the roller 92 and transported thereby, further on the hemp plants come to lie between first conveyor belt 90 and second conveyor belt 91. The second conveyor belt 91 is a relatively short conveyor belt and extends in upward direction over its whole length. The second conveyor belt 91 is trained around said roller 93, a number of further rollers 94, 95 and 116 and a driven pulley or roller 96. The third conveyor belt 91′ of the third passage 41³ has essentially the same construction as the second conveyor belt 91, except in mirror image and driven by a drive pulley or drive roller 96″.

The first conveyor belt 90 is a lot longer than the second conveyor belt 91 and extends over a part of its length in upright state, but along a different part of its length the position of the conveyor belt is rotated from the upright position to a lying position, and further along from a lying position back to an upright position. The first conveyor belt 90 is trained around said roller 92 and a number of further rollers 113, 96 (via second conveyor belt 91), 102, 112, 115, 101, 97 (roller 97 is driven), 100, 99 and 98 (as seen in transport direction). The fourth conveyor belt 90′ of the fourth passage 41⁴ has essentially the same construction as first conveyor belt 90, except in mirror image and driven by a drive pulley or drive roller 97′ and trained over rollers 92′, 113′, 96′ (via third conveyor belt 91′), 102′, 112′, 115′, 101′, (driven) 97′, 100′, 99′ and 98″.

As elucidated above, in the embodiment of FIG. 5 a larger number of passages is formed per frame part 30, 33 than in the embodiment of FIGS. 6A and 6B. In order to realize this greater number and still realize the overall width of frame part 30 of picking element 25 and/or frame part 33 of the upper hemp picking element 26, two further drive pulleys 96″, 96′″ are arranged at a number of positions axially displaced relative to those of the above described drive pulleys or rollers 96, 96′, 97, 97′. These further drive pulleys have a similar operation as the above stated drive pulleys 96, 96′. Just as the above stated drive pulleys 96 and 96′, the further drive pulleys 96″ and 96′″ are moreover embodied for axial displacement on the respective frame part 30 and 33, as will be described below.

FIGS. 8A and 8B show a schematic view of an example of a drive 195 of drive pulleys 206, 207, 206, 207′ of conveyor belts 200, 201, 200′. 201′ of a flax picking machine 190 according to the prior art. This per se known drive 195 comprises a shared, central drive motor 210 which is connected via a transmission mechanism 211 to each of the drive pulleys 206, 207, 206′. 207′. As shown in FIG. 8B, central drive motor 210 extends vertically relative to the picking frame 191 of flax picking machine 190. In the shown example the drive 195 is mounted on the underside of picking frame 191. The transmission mechanism 211 is housed in a gearbox 197, which is likewise mounted under picking frame 191. Transmission mechanism 211 is configured to transmit the rotation of the drive shaft of the central drive motor 210 to each of the individual rollers or pulleys 206, 207, 206′. 207′ of conveyor belts 200, 201, 200′. 201′. The transmission mechanism 211 in gearbox 197 comprises mechanical transmission elements such as toothed wheels (for instance toothed wheels 222, 223) and the like. The relevant drive pulleys 206, 207, 206′. 207′ are set into rotation from gearbox 197 with transmission mechanism 211 via respective drive shafts (for instance shafts 220, 221 as shown in FIGS. 8A and 8B). These drive shafts have a relatively great length, this because a relatively great distance (in height direction) between the upper side of the gearbox and the underside of the drive pulley must be bridged so as not to get in the way of the fibre crop during transport. This latter will be further elucidated in the following.

The known construction has a number of drawbacks. The transmission mechanism 211 in the central gearbox 197 can cause energy inefficiency, wear and relatively high costs for maintenance and repairs. A further draw back is that gearbox 197 extends over the whole width or at least a large part of the width of picking frame 191 in order to drive all drive pulleys distributed over the width (so in lateral direction). This means that the gearbox 197 will potentially be in the way of the fibre plants (v) passing in upright position (FIG. 8B). In order to prevent the lower outer ends (vₒ) of the fibre plants (v) from being stopped by the continuous gearbox 197, gearbox 197 must be arranged sufficiently far below the underside of picking frame 191.

If the fibre plants (v) held between two conveyor belts are transported, they define a narrow imaginary throughflow space 141 (designated with broken lines in FIG. 8B). The throughflow space 141 is defined as the space passed through by the fibre plants when they are transported between two conveyor belts. Throughflow space 141 has a lower boundary 142 which is defined by the lower outer ends (vₒ) of the fibre plants and an upper boundary 143 which is defined by the upper outer ends of the fibre plants. The central gearbox 197 extending over the width of picking frame 191 must come to lie further below the picking frame 191 than indicated by the lower boundary 142 of throughflow space 141. This arrangement is shown further in FIG. 8B.

A draw back of this arrangement is that the total construction requires a relatively great deal of height on the underside of the picking frame 191 of picking machine 190. Referring to FIGS. 8B and 11, the distance (a) between the underside of picking frame 191 and the underside of drive motor 210 and/or gearbox 197 is typically more than 70 cm. This makes it possible to guarantee sufficient ground clearance between the underside of picking machine 190 and the ground. It has further been found by the inventors that it is hereby practically impossible to realize a compact picking machine with two picking frames one above the other in which at least the gearbox 197 of the upper picking frame is in the way of the lower picking frame.

A further draw back of the use of the above stated gearbox is that, with such a box, one is always limited to predetermined fixed positions and fixed diameters in respect of the positions of the drive drums (drive pulleys).

FIGS. 9-16 show examples of favourable embodiments of a picking element 25 wherein at least a number of the above stated drawbacks is obviated. In a determined embodiment the picking element 25 comprises a plurality of drive units for the drive pulleys 96, 97, 96, 97. Each of the drive units comprises (at least) one drive motor 120. The drive motors 120 are configured and arranged to drive one pulley 96, 96′, 97, 97′ each. In other embodiments (not shown) pulleys 97, 97′ are also driven directly, but adjacent pulleys 96, 96′ are simultaneously driven by one drive unit in indirect manner via a transmission mechanism.

When one pulley is driven, this can take place in direct manner, so in principle without interposing of a transmission mechanism which may or may not be arranged in a gearbox. An embodiment wherein all drive pulleys are driven in this direct manner is shown in FIGS. 9 and 11. In this embodiment the output drive shaft 124 (FIG. 10B) of a drive motor 120 of a drive unit 118 engages directly on a drive element, such as a central rotation element 89 of the relevant drive pulley 96, 96, 97, 97′, without interposing of gear transmissions and the like. This means that the drive of a picking unit 25 can be embodied relatively small.

Each of the drive units 118 is further positioned adjacently of the relevant throughflow space 141. Three throughflow spaces 141 are shown in the view of FIG. 11, each defined between two adjacent conveyor belts for transporting fibre plants (v) in the throughflow space formed therebetween. It is clearly visible that all drive units 118 (in other words all drive motors, since a drive unit has in principle no transmission mechanism in the shown embodiment) are positioned adjacently of throughflow spaces 141 as a whole and that no single part of a drive unit 118 is in principle situated under or above a throughflow space 141. The fibre plants (v) thus have unimpeded access through the respective throughflow spaces 141.

It is further noted that when two (or more) throughflow spaces are situated adjacently of each other, a drive unit can be provided between two adjacent throughflow spaces. The drive unit is thus situated both adjacently of and between the throughflow spaces. In other embodiments the drive unit is indeed situated adjacently of one of the throughflow spaces, but not therebetween.

In FIG. 16 the arrangement of FIG. 11 is further elucidated. This figure shows a top view of two throughflow spaces 141. The broken lines indicate areas 134¹-134⁴ where no drive units are situated (where a part of the drive, i.e. the gearbox, is situated in the examples of the prior art of FIGS. 8A and 8B).

When in determined other embodiments two adjacent drive pulleys are driven simultaneously by one drive motor, such as the drive pulleys 96, 96′, this can take place in indirect manner. An example of such an embodiment is shown in FIGS. 10A and 10B. The output shaft 124 of drive motor 120 is connected via a compact transmission mechanism 128 to the two drive pulleys 96, 96″, more particularly to respective central rotation elements 129, 129′ of the drive pulleys 96, 96′. When two pairs of drive pulleys 96, 96′ are for instance arranged in indirect manner, a transmission mechanism 128 will be situated in areas 134² and 134⁴. These transmission mechanisms 128 do not however impede passage of the fibre plants (v) because there is no throughflow space 141 anyway at the position of the areas 134² and 134⁴.

An advantage of the above stated direct or indirect drives is that it is possible to select all individual positions of the drive units more or less freely. This allows for more freedom in the design of the picking unit. The expanded option of selecting the positions of the drive units (and thereby the drive pulleys) for instance has the result that the drive drums/pulleys can be positioned such that the transport flow can be brought to one side of the machine. By separating flow rates it is further possible to obtain smaller hydraulic flows in the hydraulic drive system, whereby rapid couplings can for instance be utilized at high pressure. If only one drive motor were to be applied for driving all drive pulleys, these hydraulic flows would become too high in combination with pressure.

The shown drive also makes it possible to reduce the dimensions of the picking unit 25 in the height but also in the width. The smaller drive, which certainly also requires less height, further enables two picking units (for instance picking units 25 and 26 of FIG. 7) to be embodied one just above the other. This still leaves space for the picking units 25, 26 to be able to pivot relative to each other in height direction to sufficient extent. The compact drive thereby increases the options of simultaneously picking the upper parts of the hemp plants and the lower parts of the hemp plants in efficient manner with a single vehicle, also if the height of the fibre plants varies greatly while a vehicle travels.

FIG. 13 shows schematically with broken lines 197^{A} and 197^{B} the point to which the gearboxes of the traditional drive, such as for instance shown in FIGS. 8A and 8B, would extend on the underside of respectively the lower picking element 25 and the upper picking element 26 if this traditional drive were to be arranged on the picking elements according to an embodiment of the invention.

Referring to FIGS. 9, 10A, 10B and 13, the new drive can be embodied such that the overall height (c₁) for the direct drive (FIG. 9) amounts to about 25 cm and the height (c₂) for the indirect drive (FIGS. 10A, 10B) amounts to about 30 to 40 centimetres (typically 5 to 15 cm for the transmission mechanism and 25 cm for the (hydraulic) drive motor 120. Depending on the manner of mounting of the drive unit on frame 191, the distance (b, see FIG. 13, more particularly b₁ for the direct drive of FIG. 9 and b₂ for the indirect drive of FIGS. 10A and 10B) over which drive unit 118 extends below the frame 191 amounts to roughly 10-30 cm (i.e. b₁ is typically often 15 cm or less, b₂ is typically often 30 cm or less). The above stated height (a) over which the traditional drive would extend below the frame 191 of a respective picking element 25, 26 is many times greater than the height (b) (see FIG. 13) over which the drive motors 120 according to embodiments of the present invention extend below a picking element 25, 26, so b<<a, for instance (b/a)<0, preferably (b/a)<0.1 or even (b/a)<0.05).

An additional advantage of the shown direct drive is that no or fewer mechanical transmission elements, such as drive shafts (for instance 174, 175), bearings and toothed wheels (for instance 222, 223), are necessary.

The motors 120 are for instance hydraulic motors 120 (for instance orbit motors or radial piston motors) and/or electric motors (for instance DC motors). In the case of hydraulic motors use can be made of the hydraulics of vehicle 1 itself, as will be elucidated below. In the case that electric motors are used, the power supply also takes place from (the power supply of) the vehicle itself.

In the simplest variant of such embodiments each drive motor 120 of the plurality of drive motors drives a single of the driven pulleys 96, 96′, 97, 97′. As already stated above, it is however also sometimes possible, depending on the embodiment of picking element 25, to have determined pairs of pulleys 96, 96′ which lie close together each be driven collectively by a single drive motor 120 from the plurality of drive motors 120. In determined embodiments it is for instance possible to have two pairs of pulleys of different conveyor belts (for instance, among others, the pair of pulleys 96, 96′ for conveyor belts 90, 91, 90′, 91′) each be collectively driven by a single drive motor 120, and to have two more pulleys 97, 97′ be driven individually by further drive motors 120. The number of drive motors 120 can hereby be reduced. 3-4 drive motors 120 are therefore for instance necessary in a picking element 25 with 4 to 6 driven pulleys in the latter stated embodiments 2-6.

FIG. 12 shows a bottom view of an embodiment of a picking element 25 comprising a plurality of drive motors 120 for the pulleys 96, 96′, 96″, 97, 97′, 97′″. Shown here are hydraulic and/or electric power supply lines 121 which lead to connecting points 122a, 122b on the rear side of the picking elements. These connecting points 122a, 122b can be coupled to corresponding connecting points on vehicle 1 Latter stated connecting points are connected via hydraulic and/or electric power supply lines (not shown) of vehicle 1 to respectively the above stated hydraulic pump unit for supplying a hydraulic drive medium for each of the drive motors 120, or an electric power source (not shown) provided for this purpose on vehicle 1, for instance the generator of the above stated combustion engine.

Picking element 25 can comprise one or more connecting points 122a, 122b for connecting the power supply means 121a, 121b to a power supply installation of vehicle 1. From these connecting points 122a. 122b the power supply lines 121a, 121b can follow the structural elements of the frame part 30 of picking element 25. This may reduce the chances of impedance or damage. It is possible to connect a plurality of motors 120 to the same power supply lines 121a, 121b. This is preferably done in series. In the embodiment shown in FIG. 9 two times three motors 120 are for instance connected in series to own power supply means 121a, 121b, each with their own connecting point 122a, 122b. It will be apparent to the skilled person that many variants are possible here.

Referring to FIGS. 6 and 10, which show an example of an upper hemp picking element 26, transport installation 45, 46 grips in each case the upper parts (h₂) of the hemp plants (h) via each of the passages 41 and process them further. The upper parts (h₂) of the hemp plants are pulled inward into said passages. In the drawings a small number of fibre plants (h) is shown with black dots, although in practice this number will of course be much greater and a substantially continuous row of fibre plants will be transported between the endless conveyor belts 90, 91 and 90′, 91′. As stated above, the cut-off fibre plants (h₂) extend in upward (vertical) direction in the first part of each of the passages, and further along in transport installation 45, 46 the cut-off hemp plants (h₂) are rotated through a quarter turn to a lying (substantially horizontal) position (fibre plant parts h₂ then being shown in broken lines). Once in this lying position, the fibre plants are transferred from an endless belt conveyor to a further endless belt conveyor (i.e. conveyor 50 of the upper hemp picking element 26 and conveyor 51 of the lower hemp picking element 25).

FIGS. 5, 6A and 6B show the operation of transport installation 45 and the turning over of the hemp plants in more detail. The two streams of hemp plants which enter via passages 41¹ and 41² converge between conveyor belts 90 and 91. The hemp plants (h₂) are then transported on between conveyor belts 90, 91 and, after having passed the driven pulley or roller 96, reach said collecting area 117. In the embodiment of FIGS. 6 and 10 the streams from passages 41¹/41² and 41³/41⁴ converge in this collecting area 117. FIG. 5 shows an embodiment where the combined streams of passages 41¹ and 41² on one side and the combined streams of a number of other passages on the other converge in collecting area 117. In the embodiment shown in FIG. 6 these are passages 41³ and 41⁴, but in other embodiments they are the streams from passages 41³, 41⁴, 41⁵ and 41⁶ which in turn have already converged previously in a collecting area 117″.

As shown in FIGS. 5, 6A and 6B, both conveyor belt 90 of the first and second passages 41¹ and 41² and the conveyor belt 90′ of the third and fourth passages 41³-41⁴ (or third to sixth passages in the embodiment of FIG. 5) are tilted after passing both rollers 102, 102′ in that the respective belts 90, 90′ are guided over rollers 112 having a rotation axis which lies perpendicularly of the rotation axis of rollers 102, 102″.

The picking and further processing of the upper parts (h₂) by means of the upper picking unit 26 is described in detail with reference to the figures. The lower parts (h₁) of the hemp plants (h) are similarly picked and further processed by the lower hemp picking element 25. A detailed description of the way in which these lower parts (h₁) of the hemp plants are gripped and processed can therefore be dispensed with. The lower hemp parts (h₁) are gripped and carried along in similar manner by a transport installation 45, rotated through a half turn until they are in horizontal position and then discharged by a conveyor 51.

FIGS. 14 and 15 show views of two first adjusting mechanisms 103 for adjusting the positions of the above stated non-driven further rollers 100, 100′ (shown in for instance FIGS. 5, 6A and 6B) for tensioning or slackening respective conveyor belt 90 and 90′. The adjusting mechanism 103 for adjusting the position of the further roller 100 is essentially the same as the adjusting mechanism for adjusting the position of the further roller 100′, and a description of one the two first adjusting mechanisms 103 will therefore suffice here.

Adjusting mechanism 103 comprises a first arm 104 which is arranged pivotally on the frame of the relevant picking unit 25, 26 via an upright rotation shaft 105. Arm 104 is also mounted rotatably on a second arm 106 via shaft 109. The opposite outer end of the second arm 106 is mounted rotatably via shaft 109 on a hydraulic (or electric) actuator 107, such as the shown extending cylinder, which is arranged rotatably on the frame via rotation shaft 108. By adjusting the length of the actuator (direction 110) the position of the roller 100, 100′ can be displaced (direction 111). In the position of FIGS. 14 and 15 the relevant conveyor belt is tensioned. When the actuator 107 is however made longer, the relevant roller 100, 100′ moves such that the internal tension in the conveyor belt increases (conveyor belt is tensioned). When actuator 107 is made shorter, the relevant roller 100, 100′ will once again tend to reduce the tension in the relevant conveyor belt (conveyor belt is slackened).

FIGS. 14 and 15 also show two further adjusting mechanisms 123 for adjusting the positions of the above stated indirectly driven pulleys 96 and 96″ (shown in for instance FIGS. 5, 10A and 10B) for tensioning or slackening respective conveyor belt 91 and 91′. The adjusting mechanism 123 for adjusting the position of drive roller 96 is essentially the same as the adjusting mechanism for adjusting the position of drive roller 96′, and a description of one the two second adjusting mechanisms 123 will therefore suffice here.

As shown in FIGS. 14 and 15, the second adjusting mechanism 123 can ensure that the corresponding drive roller 96 is displaced in axial direction 130. The drive pulley 96 drawn with full lines is in the tension position, in which the conveyor belt is tensioned and the internal tension in the conveyor belt is therefore high. In operative state the drive pulley 96 is usually in this position. Broken lines show the same drive pulley 96 when it is in the non-tensioned position, in which the conveyor belt is slacker and the internal tension in the conveyor belt is relatively low. In this position of drive pulley 96 the conveyor belt can be easily removed (for instance for maintenance), or can be easily replaced with a new conveyor belt. A further advantage is that a blockage or obstruction between the conveyor belts can be remedied (unblocked) more easily. The two drive pulleys 96, 96′ can be displaced together with the drive motors 120 corresponding therewith and mounted thereon, as will be elucidated below.

The two drive motors 120, i.e. a first drive motor 120 for driving first drive pulley 96 and a second drive motor 120 for driving second drive pulley 96′, are mounted on a single, shared support 126. This shared support 126 is mounted on frame part 30, 33 such that the support is displaceable in axial direction (i.e. in direction 130). When support 126 is displaced, the drive pulleys 96, 96′ supported thereon and the drive motors 120 arranged on the drive pulleys 96, 96″ are also displaced in axial direction. Driving of support 126 is done by means of an actuator 125, for instance a hydraulic cylinder or an electric actuator, mounted on the relevant frame part 30, 33. The actuator 125 is mounted with one outer end 127 fixedly on frame part 30, 33 and mounted with the other outer end on support 126. By increasing the length of actuator 125 the support 126 is displaced rearward, by decreasing the length the support 126 is displaced forward.

In other embodiments (not shown) a support is provided for each of the drive pulleys 96, 96′, and the drive pulleys can be individually displaced in axial direction for operation of the corresponding actuators.

In embodiments with one drive motor per drive pulley, the displacement of the drive pulleys and the drive motors 120 mounted thereon is possible because the drive motors 120 are connected directly to the drive pulleys without interposing of a gearbox or the like. This is because, if the above stated large (central) gearbox for all drive pulleys collectively is present, the drive motors would first have to be uncoupled from the gearbox, the transmission would have to be displaced or adapted, and the drive motors would then have to be coupled to the gearbox again. This is impossible in a practical sense and/or requires an unacceptably long change-over time of the machine. Such a transmission is furthermore relatively heavy, and extensive provision is necessary to enable the displaceability of the drive pulleys.

The present invention is not limited to the embodiments described herein. The rights sought are defined by the following claims, within the scope of which numerous modifications can be envisaged.

1. A fiber plant picking apparatus configured to be mounted on a vehicle chassis of a vehicle to pick fiber plants, the fiber plant picking apparatus comprising:
one or more picking elements, each of the one or more picking elements comprising:
a frame part,
a mounting system configured to mount the frame part releasably on the vehicle chassis, and
a fiber plant picking and transport installation arranged on the frame part, the fiber plant picking and transport installation comprising:
a plurality of pulleys,
at least one pair of endless conveyor belts trained over the plurality of pulleys and configured to grip the fiber plants therebetween and to pick and then transport the fiber plants in a gripped state, at least one of the pulleys corresponding with one of the conveyor belts being a drive pulley, a throughflow space through which the fiber plants are transported being defined between the at least one pair of conveyor belts, and
a plurality of drive devices, each of the drive devices having only one drive motor configured to drive only one or only two drive pulleys of one or more corresponding ones of the endless conveyor belts, each of the drive devices being positioned adjacent to the respective throughflow space.

2. The fiber plant picking apparatus according to claim 1, wherein at least one of the drive units devices has only one drive motor and is configured to drive only one drive pulley.

3. The fiber plant picking apparatus according to claim 1, wherein at least one of the drive motors is configured to drive a transmission mechanism that is coupled to two adjacent drive pulleys.

4. The fiber plant picking apparatus according to claim 2, wherein the drive motor extends as a whole adjacent to one or more of: (i) a lower part of the throughflow space and (ii) an upper part of the throughflow space.

5. The fiber plant picking apparatus according to claim 2, wherein the respective drive motors each include a drive shaft mounted directly on a central rotation element of a drive pulley.

6. The fiber plant picking apparatus according to claim 3, wherein a transmission ratio of the transmission mechanism is substantially 1:1, so that in an operative state, the rotation speed of the drive motor is equal to the rotation speed of a respective one of drive pulleys driven by the drive motor.

7. The fiber plant picking apparatus according to claim 1, further comprising a plurality of power supply lines for the drive motors, wherein the power supply lines comprise connecting points configured to connect the power supply lines to a power supply installation on the vehicle.

8. The fiber plant picking apparatus according to claim 7, wherein the power supply installation comprises a hydraulic pump provided on the vehicle.

9. The fiber plant picking apparatus according to claim 7, wherein the power supply lines extend along structural elements of the frame part.

10. The fiber plant picking apparatus according to claim 1, wherein each of the drive motors is configured to be controlled independently of the remaining drive motors.

11. The fiber plant picking apparatus according to claim 1, wherein a plurality of the drive motors is connected to same power supply lines, in series.

12. The fiber plant picking apparatus according to claim 1, wherein the drive motors are hydraulic drive motors.

13. The fiber plant picking apparatus according to claim 1, wherein one or more of the drive motors are electric.

14. The fiber plant picking apparatus according to claim 1, wherein each of the drive motors drives only one single drive pulley of the pulleys of the endless conveyor belts.

15. The fiber plant picking apparatus according to claim 1, wherein one or more of the drive motors each drives a pair of drive pulleys of different endless conveyor belts which lie close together.

16. The fiber plant picking unit system according to claim 1, further comprising an adjusting mechanism configured to adjust an axial position of at least one of the drive motors together with the drive pulley mounted directly thereon relative to the frame part.

17. The fiber plant picking apparatus according to claim 1, wherein at least one of the drive pulleys is rotatably disposed on a support displaceable along the frame part in an axial direction.

18. The fiber plant picking apparatus according to claim 16, wherein the adjusting mechanism comprises a hydraulic or electric actuator disposed between the support and the frame part and configured to adjust an axial position of the support and the combination of the drive pulley and the drive motor arranged thereon.

19. A fiber plant picking machine configured to pick and process plants, the fibre plant picking machine comprising:
a self-propelling vehicle comprising
a vehicle chassis with at least one conveyor configured to transport picked and processed fiber plants in at least two streams from a first outer end to an opposite second outer end, and
at least one delivering system provided at or close to the second outer end to receive the respective streams of picked, processed and transported fiber plants and then place the received fiber plants on the ground in at least two rows; and
the fiber plant picking apparatus according to claim 1, mounted or mountable on the vehicle chassis.

20. The fiber plant picking machine according to claim 19, wherein the fiber plant picking apparatus further comprises:
a first pivotable picking element configured to pick a lower part of the fiber plants relative to the ground surface, and
a second picking element disposed above the first picking element and configured to pick an upper part of the fiber plants relative to the ground surface.

21. The fiber plant picking machine according to claim 20, wherein the first picking element has a first transport installation configured to grip the lower part of the respective fiber plants, pull the gripped fiber plants from the ground along with roots of the fiber plants, and transport the lower parts of the fiber plants to the at least one conveyor of the vehicle, and
wherein the second picking element has a cutter configured to cut the fiber plants at a position between the upper and lower parts of the fiber plants, the second picking element having a second transport installation configured to grip the upper part of the respective fiber plants and to transport the upper parts of the fiber plants to the at least one conveyor of the vehicle, the cutter being configured to cut the fiber plants during transport.

22. The fiber plant picking machine according to claim 20, wherein the first and second picking elements are disposed relative to each other such that during travel of the vehicle the second picking element first grips and cuts loose the upper parts of the fiber plants and only then does the first picking element grip the lower parts of the fiber plants.

23. The fiber plant picking machine according to claim 20, further comprising one or more of:
(i) a first lift disposed between the vehicle chassis and the first picking element, the first lift being configured to set a pivot position of the first picking element relative to the vehicle chassis, and
(ii) a second lift disposed between one or more of: (i) the vehicle chassis and the first picking element and (ii) the first and second picking elements, the second lift being configured to set a pivot position of the second picking element respectively relative to one or more of the vehicle chassis and the first picking element.

24. A method of using the fiber plant picking apparatus according to claim 1.

25. A method of picking and processing fiber plants with the fiber plant picking machine according to claim 19, the method comprising:
driving a maximum of two of the drive pulleys per respective drive motor.
